(19) United States
(12) Patent Application Publication
(10) Pub. No.: US 2023/0060734 A1
(43) Pub. Date: Mar. 2, 2023

(54) Secure, Movable Vending Structure

(71) Applicant: Ronnie Boswell, Muskogee, OK (US)

(72) Inventor: Ronnie Boswell, Muskogee, OK (US)

(21) Appl. No.: 17/722,962

(22) Filed: Apr. 18, 2022

Related U.S. Application Data
(60) Provisional application No. 63/176,033, filed on Apr. 16, 2021.

(51) Int. Cl. B60P 3/025

(52) U.S. Cl. CPC B60P 3/0257

(57) ABSTRACT

A portable vending structure comprising: exterior walls, a roof and a floor all defining a main structure; at least one transaction window defined in a wall; at least one ATM mounted in a wall; at least one sign removably mounted at an upper edge of a wall; a safe room defined within the structure with heightened physical security features including a secure entry door; electronic systems including at least one camera, an interact connection, at least one point of sale system, and at least one power distribution system. The structure may include a second floor removably mounted: on top of the main structure, the second floor serving as a customer lounge for consuming products vended on the main floor. The second floor preferably includes a vent means for venting fumes from the second floor comprising either floor grates up through which at least one fan blows air or a vent hood with a powered fan drawing fumes up and away from the second floor.

### CROSS-REFERENCE TO RELATED APPLICATIONS

None.

### FIELD OF THE INVENTION

The invention generally relates to movable vending structures, More particularly, the invention relates to vending herbal products, particularly in environments where a substantial volume of cash transactions are expected.

### BACKGROUND

It is well known to provide movable structures for vending food, beverages or consumer products in a temporary location. The layout and features of such movable vending structures vary depending on the nature of the products or services being sold, the place where they are to be used, the distances over which the structures may be transported, and the need for ease and speed of setup, and according to a variety of other factors.

Movable vending structures range from carts vending hot dogs on the street to large semi-trailers. See, for example, U.S. Pat. No. 3,748,437 for a Mobile Food Concession Cart of the type commonly seen on the street vending hot dogs. Most vending structures are trailers, where the structure is permanently mounted on wheels with a means for affixing the structure to a vehicle capable of towing it to a desired location. However, it is also known to provide mobile structures that must be loaded onto a separate trailer for transport. See, for example, U.S. Pat. No. 3,095,616 for a Portable Building and Apparatus for the Transportation and Erection of the Same.

### SUMMARY OF THE INVENTION

The present invention comprises a portable structure (preferably configured as a “Conex” car intermodal shipping container). The structure is transported (preferably by truck) to a venue where it is off-loaded, and the structure is used for vending herbal medicines or other similar products.

The structure preferably has two transaction windows mounted on opposite sides. The windows include bullet-proof glass and a deal tray through which payment and products can be exchanged.

LED signs are preferably mounted on the top and/or sides of the structure. The signs may be removable, and the ones on top may be attached by stake body type slide-in mounts.

A crane gin pole may be mounted on top of the trailer to lift signs and other equipment onto the roof once in place at an event. The crane gin pole is preferably collapsible or removable so that it does not strike overpasses in transport, One configuration is rotatable mounting of the crane to a back end of the trailer where it can rotate down behind the trailer when not in use.

A safe room will preferably be provided with thicker/tougher walls and a separate security door provided to access the safe room from within the structure. The safe room will be used to store excess cash and products.

An automated teller machine (“ATM”) will preferably be externally available to customers. Preferably, the ATM will project into the safe room and be able to be loaded with cash from within the safe room.

Internal storage will preferably be provided to hold the products being sold, Most products will be dry and room temperature, likely stored in bins or on shelves. Other products may include refrigerated products such as THC-infused water, so a refrigerator will be provided. The internal storage may be a cabinet with its own ventilation to prevent fumes emanating from stored products from entering the occupied space of the structure.

Significant electronics will be provided including lights and power outlets. The electricity may come from a remote connection to the grid, from solar, or from a generator. Electronics in the structure will preferably include: a) video monitoring with a digital video recorder (“DVR) preferably disposed inside the safe room; h) a security alarm system with standard options for a mode when the vending trailer is occupied/in operation and for when it is not in operation unoccupied; c) an internet connection by wireless, wired, or satellite for use with respect to the security, video, ATM and possibly payment processing systems; d) a point of sale system available to each operator in each window; and e) an audio system with external speakers.

HVAC systems will keep interior temperature controlled both for comfort of the operators and for quality control on products. The HVAC system may have designed replacement air to ensure that odors emanating from products do not become excessive.

Anchors to secure the structure in place may be provided. The anchors may be either external or internal. Internal anchors would further deter potential theft of the entire structure and may preferably secure the system to the ground by means only accessible within the safe room.

Disposed on the roof may be a consumption lounge. The signs could serve as rails or safety barriers, or actual fencing may be provided to prevent falls. Access to the consumption lounge could be via fixed or retractable stairs or via an elevator or lift system. An elevator could provide more controlled access to the lounge and minimize the chance for falls down a set of likely metal stairs. Access to the lounge may be timed with the amount of time available tied to the dollar value of the purchase or additional time purchases available for a specified price.

A ventilation system may be provided for the consumption lounge. The lounge may have a pitched roof in which a vent draws air from the inside the peak and blows it up and out of a vent pipe. Another option is a floor grate on top of the roof with fans blowing up through it.

A vending portal may be externally accessible by customers. The vending portal would preferably have a point-of-sale system, facial recognition capability, an identification card scanner, and optionally a data entry pad. The vending portal may accept payment, scan a customer's face, compare the facial scan with a scanned identification card, accept an herbal medicine license number or other identification number entered by keypad or by scanning a permit or identification card, and dispense products customers pay for by card or cash fed into the portal.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out several purposes of the present invention. Additional benefits and advantages of the present invention will become apparent to those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a side view of the vending structure with the optional second floor included.

FIG. 2 is an end view of the vending structure with the optional second floor included.

FIG. 3 is a floor plan of the vending structure's first floor.

### DETAILED DESCRIPTION OF THE INVENTION

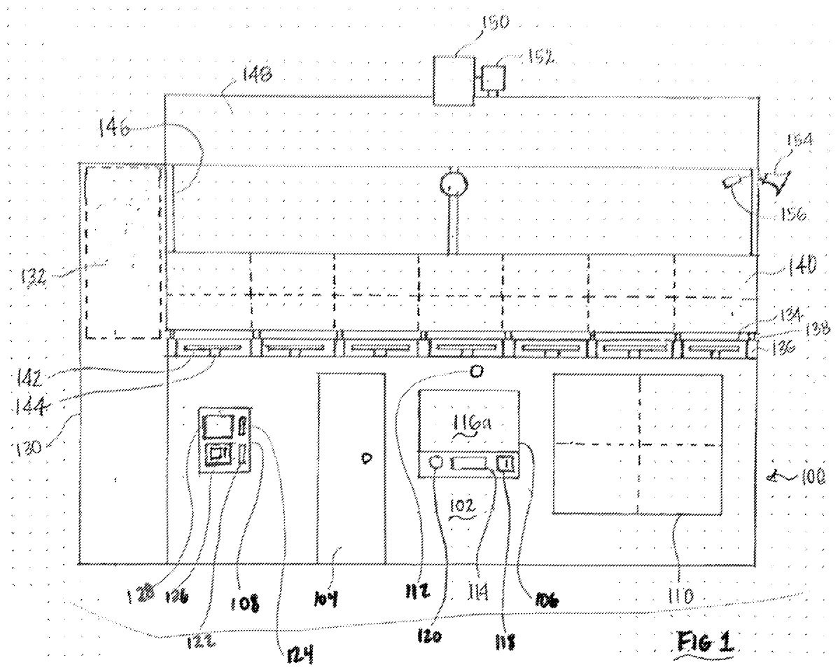

A structure 100 according to the present invention is shown in FIG. 1. FIG. 1 is a side view of the vending structure 100. Present at the bottom is a wall 102, of the vending structure 100. Defined in the wall 102 is a door, 104. A transaction window 106 is also placed within the wall 102. A sign 110 is preferably provided on the wall 102, for example for use to display available products and pricing. The sign 110 may either be a printed or painted sign, or it may be an electronic sign that will be discussed in more detail later. The sign 110 as shown in FIG. 1 has dashed lines indicating separate monitors which are molded together to create a larger unitary sign that appears as one screen. An automated teller machine (“ATM”) 108 is also mounted on the wall 102 as well. The ATM projects back into a safe room 300 that will be discussed below, A camera 112 is mounted above the transaction window 106. There may also or instead be a camera mounted within the body of the transaction window 106. Multiple cameras 112 are placed around the vending structure 100 for security given that high-value products and lots of cash may be handled as a part of the business. Preferably, the opposite side of the structure replicates the elements described above (other than the door for which it is anticipated there will not be more than one on a side).

The transaction window 106 has a transaction tray 114 that allows a worker to pass products out to a customer and the customer to pass cash or other payment in to the worker. The glass 116 in the transaction window is preferably “bulletproof” for security. A data port 118 is defined on the outside of the transaction window 106. The data port 118 may include a keypad and/or a card reader. In a preferred embodiment, for unmanned operation, the data port includes the ability to read a picture identification from the customer and to use an integrated camera to face match the customer with the picture on the identification card. There is a transaction speaker 120 to facilitate communication between the customer and a worker.

The ATM 108 has a card reader 122 for a customer to insert their credit card, debit card or the like. It has a camera 124 to monitor security of the transactions. A keypad and dispenser 126 is present to allow entry of data such a pin and dispensing of cash. The ATM has a screen 128 to allow display of data to a customer.

A means of allowing customers to get to a second level of the vending structure 100 is provided. As shown, an elevator 130 is mounted at an end of the structure 100. Disposed within the elevator 130 is a car 132 for receiving persons. The benefit of an elevator is that it provides more controlled access to the second level. The elevator can be locked as needed to prevent unwanted access to the second floor, for example, when capacity has been reached regarding the number of people allowed to enter. A set of stairs may also preferably be provided and may be required for safety purposes. The stairs are not shown, but they would be well known to anyone skilled in the art.

A second floor of the vending structure 100 is intended to be used as a lounge for customers. In the lounge, customers can consume the herbal products preferably dispensed from the Vending Structure 100. The second floor is intended to be removable so that, when the vending structure 100 is transported, the first and second floors are separated so the height of the structure does not exceed overpasses presenting problems for transportation. Thus, the floor 134 of the second floor is supported above the first floor of the vending Structure 100 by a series of stake receivers/supports 136. The stake receivers/supports 136 are preferably mounted on an upper exterior periphery of the vending structure 100. Floor 134 is preferably a grate which allows airflow therethrough. The floor 134 is supported by a series of stakes 138 engaging the stake receiver/supports 136. The stakes are preferably affixed to a series of upper displays 140, The upper displays 140 have sufficient structural integrity to serve as a safety railing to keep customers in the second floor from falling out. The upper displays 140 may be a fixed sign that is painted or printed, or it may preferably be an electronic display. Again, hatched lines are shown indicating separate displays that are mulled together to make a contiguous display at the top of the vending structure 100.

To provide enhanced ventilation and cooling, a series of fans 142 may be mounted on top of the vending structure 100, The fan motor 144 drives the fans 142 to push air up through the grates providing both ventilation of any smoke from products consumed on the second floor as well as pushing it up towards a higher altitude where it is less likely to be detected by persons passing by the vending structure 100.

A series of posts 146 support a roof 148. The roof 148 is preferably pitched and has at a center point a vent stack 150. The vent stack 150 has a fan disposed therein driven by a vent motor 152 to pull air from underneath the roof 148 and vent it upwardly and out and away from the structure 100.

On the second floor, there is preferably provided the series of speakers 154 as well as cameras 156. The speakers 154 allow for both music for the customers as well as announcements or advertisements to be aired to both the customers in the lounge and those passing by.

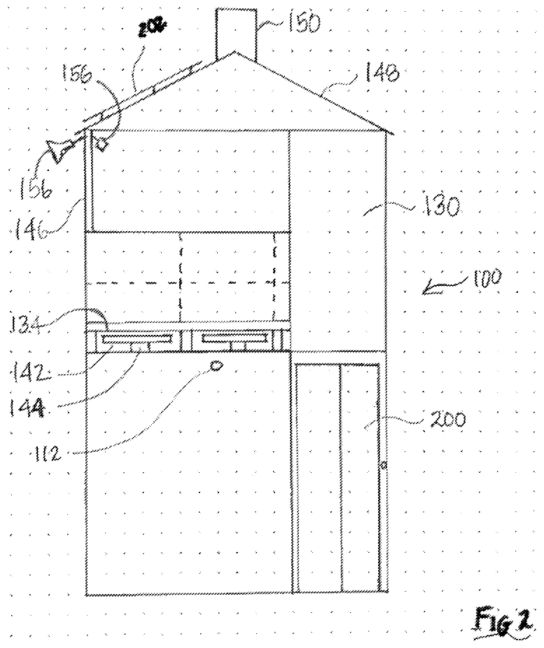

FIG. 2 is a side view of the vending structure 100, The elevator 130 can be seen, and the elevator doors 200 mounted at the lower floor thereof. Similar elevator doors are present for egress on the second floor.

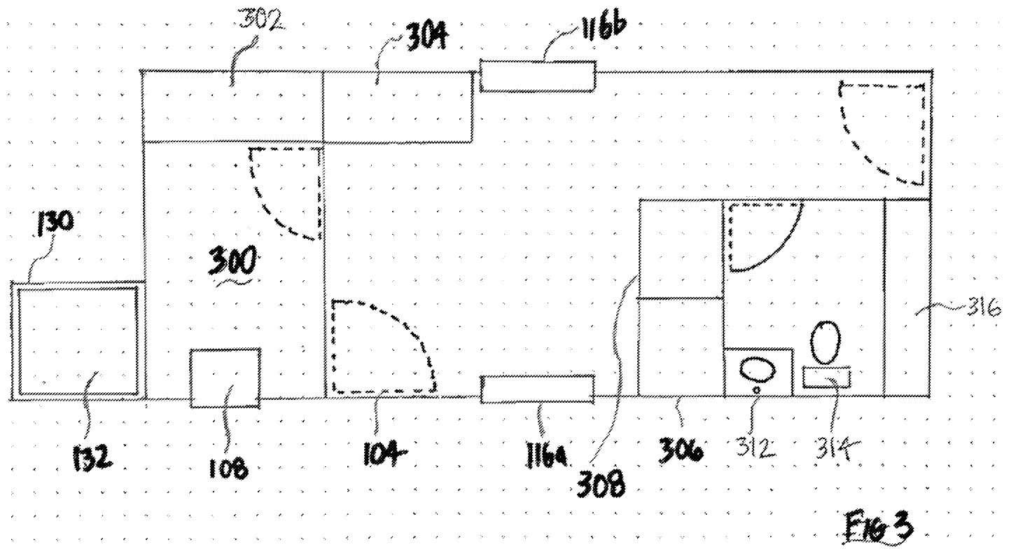

FIG. 3 illustrates a floor plan of the lower floor of the vending structure 100. At a first end adjacent to the elevator 130 is a safe room 300. The safe room 300 is a more secure portion of the vending structure 100 which includes thicker or at least more solid walls. It is expected that the safe room 300 will contain additional inventory as well as cash. There is preferably a locker 302 which may serve as a secondary safe disposed within the safe room 300. The ATM 108 projects inwardly into the safe room 300. Additional cash can be stored in the safe room 300 and reloaded securely from within the safe room 300 into the ATM 108.

The floor plan of the second floor is expected to be substantially open. It is anticipated that seating may be provided for patrons. Further, it may be desirable to provide an on-site restroom. Otherwise, it is not expected that there will be any other structures or dividers on the optional second floor.

Outside of the safe room 300 is the vending portion of the vending structure 100. It includes a first storage unit 304 and, as shown, a second storage unit 306. A number of storage units may be provided depending on the configuration. A refrigerator 308 is provided for maintaining cold products in that condition for dispensing to customers. There may be a bathroom 310 including both a sink and a toilet, 312 and 314. In a preferred environment, the floor of the bath is elevated so that underneath it are, for example, storage tanks for gray water, fresh water, as well as possibly also batteries for operation of the unit off of the grid. Additionally, for off-grid use, there may be solar panels 202 disposed on the roof 148. Finally, as shown in FIG. 3, there may be an equipment cabinet 316 which may be accessible from either inside the vending structure 100 or outside depending on preferences and security needs.

A plethora of electronics is provided including security, internet, communication with central servers to facilitate ATM and sales transactions as well as point-of-sale inventory control and the like. The electronics and any computers associated with them may be disposed within the Safe Room 300 or, they may be disposed, for example, in Equipment Cabinet 316. It is important to provide sufficient ventilation and cooling for the computer and electronic equipment to operate properly.

A heating, ventilation and air conditioning (“HVAC”) system is provided for the operating portion of the vending structure in which workers sit. The ventilation system maintains appropriate temperature as well as providing fresh air. The herbal products preferably dispensed have significant odors, so the fresh air is desirable to ensure the health and wellness of workers.

Each storage unit 304 may have its own ventilation, Fresh air can be drawn into the cabinet and vented outside the structure 100 so that the products are stored in an environment that minimizes the odors emanating into the operational space where the workers are doing their jobs.

For transportation, the units must be disassembled as noted because otherwise they would be too high to transport feasibly. The upper story is essentially one unit, and the lower story is a unit. The elevator 130 and/or stairs are separate structures. The elevator 130 is, for example, transported inside of the upper floor. The upper displays 140 are also removed from the vending structure 100 and stored within the upper structure for transport. Depending on its size and weight, the upper floor may be disassembled in pieces for easier raising/lowering, and to facilitate them being more easily transported. To facilitate disassembly, a crane may be removably mounted on the structure. The crane may be mounted within one or more of the stake receivers 136.

Having thus described the invention, I claim:

1) A portable vending structure comprising:
a) Exterior walls, a roof and a floor all defining a main structure;
b) At least one transaction window defined in a wall;
c) At least one ATM mounted in a wall;
d) At least one sign removably mounted at an upper edge of a wall;
e) A safe room defined within the structure with heightened physical security features including a secure entry door;
f) Electronic systems including:
i) At least one camera,
ii) At least one internet connection,
iii) At least one point of sale system,
iv) At least one power distribution system.

2) The structure of claim 1 further comprising: a second floor removably mounted on top of the main structure.

3) The structure of claim 2 further comprising a vent means for venting fumes from the second floor.

4) The structure of claim 3, the vent means comprising floor grates up through which at least one fan blows air.

5) The structure of claim 3, the vent means comprising a vent hood with a powered fan drawing fumes up and away from the second floor.
